(19) United States
(12) Patent Application Publication
(10) Pub. No.: US 2002/0029508 A1
(43) Pub. Date: Mar. 14, 2002

(54) Fishing net

(76) Inventor: Todd Blake, San Francisco, CA (US)

Correspondence Address: VIERRA MAGEN MARCUS HARMON & DENIRO LLP, 685 MARKET STREET, SUITE 540, SAN FRANCISCO, CA, 94105, US

(21) Appl. No.: 09/849,012

(22) Filed: May 3, 2001

Related U.S. Application Data
(60) Provisional application No. 60/201,437, filed on May 3, 2000.

(51) Int. Cl. A01K 77/00

(52) U.S. Cl. 43/11

(57) ABSTRACT

A fly fishing net is disclosed including an integrally formed handle and frame. The frame includes an interior flange in which holes are formed for receiving a mesh netting. As there are no holes drilled through the frame, the frame is not weakened by a loss of material, and no water enters into the frame. Thus, the life of the net is prolonged relative to conventional nets. The frame and handle are preferably formed of a carbon fiber material. In addition to facilitating the formation of the flange and holes therein, forming the frame of carbon fiber allows the net to be custom shaped as desired. Additionally, in comparison to convention wooden nets, a carbon fiber net is significantly lighter.

### CROSS REFERENCE TO RELATED APPLICATION

The present application claims priority to U.S. Provisional Patent Application Ser. No. 60/201,437, entitled “Fishing Net,” filed May 3, 2000.

### BACKGROUND OF THE INVENTION

1. Field of the Invention

The present invention relates to the pastime of fishing, and in particular to a net including a carbon fiber frame which is formed for durability and to allow easy entry of fish into the net.

2. Description of Related Art

It is known in the art of fishing to lift a fish out of the water using a net after the fish has been hooked. Conventional fishing nets include a wooden frame having an easy grip handle, and a mesh netting affixed to the frame. As shown in FIG. 1, which illustrates a section of a fishing net frame 20, the mesh netting is typically attached to the frame 20 by drilling holes 22 through the frame and then threading the mesh netting or line attached to the mesh netting 24 through the holes. Moreover, owing to the labor intensive nature of fabricating wooden frames, the frames have conventionally included the uniform cross-sectional shape such as shown in FIG. 1 around the circumference of the frame. Furthermore, wooden frames tend to be relatively heavy.

### SUMMARY OF THE INVENTION

It is therefore an advantage of the present invention to provide a fishing net for capturing fish which is formed of carbon fiber.

It is a further advantage of the present invention to provide a fishing net including a custom shaped frame to optimize its use for capturing fish.

It is another advantage of the present invention to provide a fishing net where no holes are drilled in the frame so as to prevent weakening of the frame and water from entering into the interior of the frame where it can potentially damage the frame over time.

It is a still further advantage of the present invention to provide a fishing net which is lightweight.

These and other advantages are provided by the present invention which in preferred embodiments relates to a fly fishing net formed of a carbon fiber material which is lightweight and easily fabricated to a customized design. The fishing net includes an integrally formed handle and frame. The frame includes an interior flange in which holes are formed for receiving a mesh netting. As there are no holes drilled through the frame, the frame is not weakened by a loss of material, and no water enters into the frame. Thus, the life of the net is prolonged relative to conventional nets.

In addition to facilitating the formation of the flange and holes therein, forming the frame of carbon fiber allows the net to be custom shaped as desired. Additionally, in comparison to convention wooden nets, a carbon fiber net is significantly lighter.

### BRIEF DESCRIPTION OF THE DRAWINGS

The present invention will now be described with reference to the drawings, in which:

FIG. 1 is a prior art cross-sectional view of a fishing net frame having holes formed therethrough to receiving a netting;

FIG. 2 is a perspective view of a fishing net according to the present invention;

FIG. 3 is a top view of a fishing net according to the present invention;

FIG. 4 is a side view of a fishing net according to the present invention;

FIG. 5 is a cross-sectional view of a fishing net according to the present invention through line 5-5 in FIG. 4; and

FIG. 6 is a cross-sectional view of a fishing net according to the present invention through line 6-6 in FIG. 4.

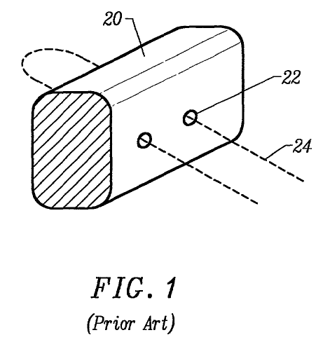

### DETAILED DESCRIPTION

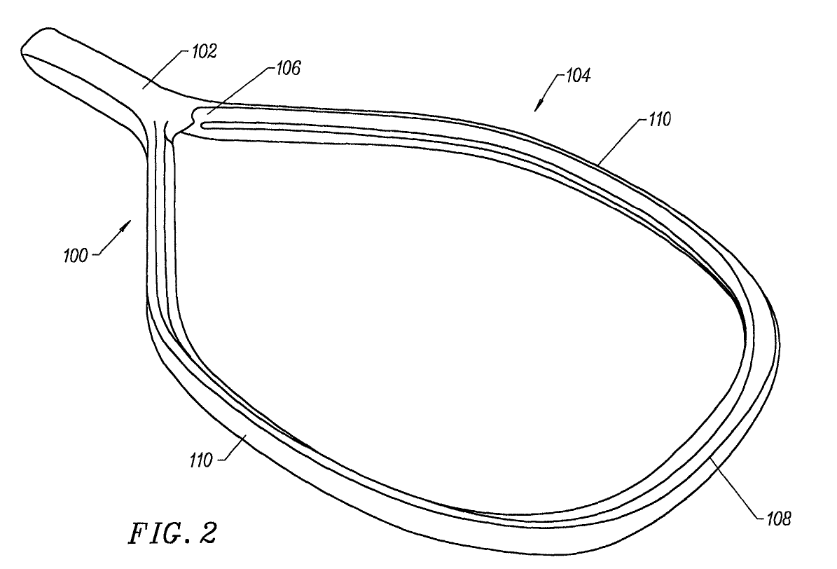

The present invention will now be described with reference to FIGS. 2-6 which in general relate to a fishing net including a carbon fiber frame which is formed for durability and to allow easy entry of fish into the net. Referring initially to FIGS. 2-4, there is shown a fishing net 100 including an integrally formed handle 102 and frame 104. The handle and frame are formed of a carbon fiber material by any of various known molding or casting processes. The frame and handle may alternatively be formed of Kevlar®, graphite, fiberglass or titanium.

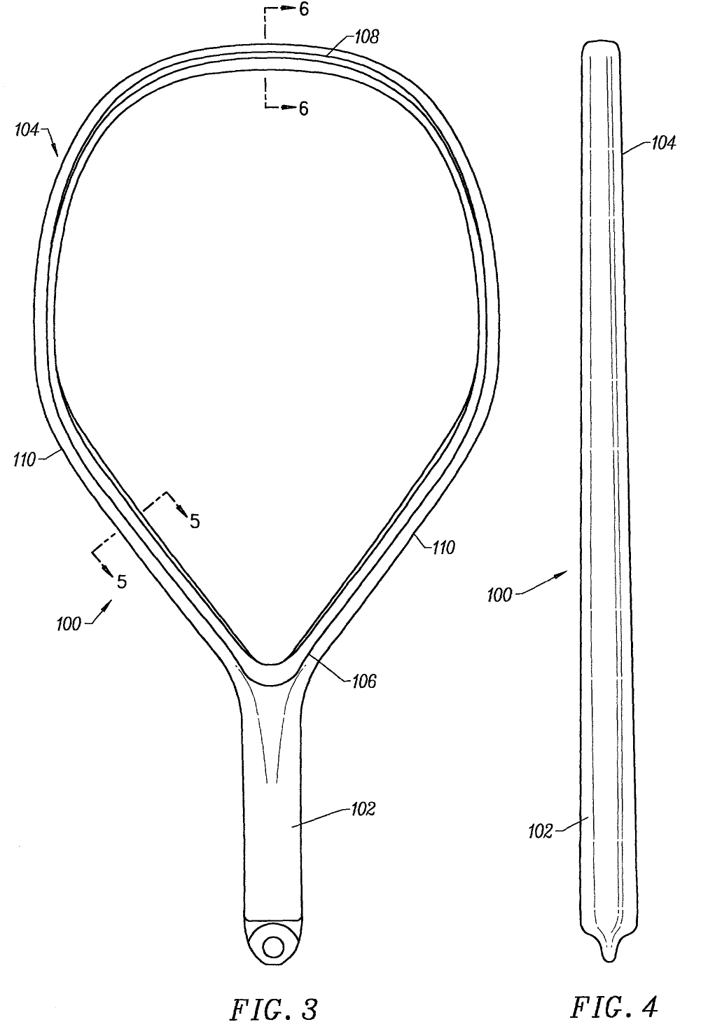

The frame 104 includes a first end 106 adjacent the handle 102, a second end 108 distal from the handle 102, and sides 110 between the first and second ends. It is understood that the shape of the frame 100 may vary from that shown in FIGS. 2 and 3 with the provision that the ends and sides define an opening sufficiently large to allow a fish of the size contemplated to be easily captured therein.

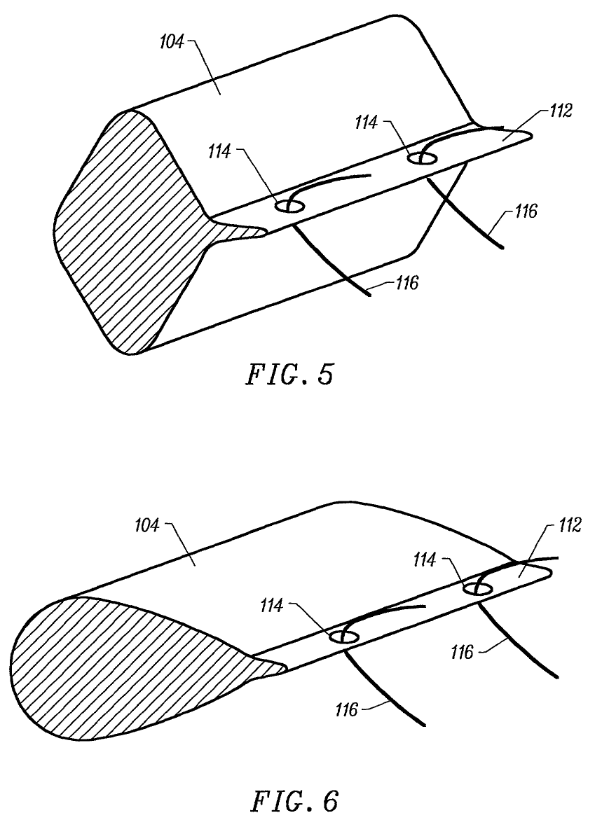

FIG. 5 is a cross section through line 5-5 in FIG. 3. As indicated in FIG. 5, as opposed to drilling through frame 104 in order to affix the mesh netting, a flange 112 is formed on the frame 104 and holes 114 are drilled or otherwise formed through the flange. The flange is easily formed during the molding or casting process. As there are no holes drilled through the frame, the frame is not weakened by a loss of material, and no water enters into the frame and the life of the net 100 is prolonged relative to conventional nets. After the frame is formed, a netting material or independent affixation line attached to the mesh netting 116 is threaded through the holes 114 in flange 112 to provide net 100. It is understood that projections and other formations for affixing the netting material 116 to frame 104 may be easily fabricated on the inner-facing surface or outer facing surface of the frame instead of the flange 112 in alternative embodiments.

Another advantage of forming net 100 out of a carbon fiber material in a casting process is that the frame may be formed in a customized shape adapted to optimize its use for capturing fish. For example, as shown in FIG. 6 which is a sectional view through line 6-6 in FIG. 3, the end 108 of the frame 104 may be flatter and wider than the rest of the frame. Making end 108 flatter and wider makes it easier for a caught fish to slide over the end 108 and into the net 100 in comparison to a conventional net having a thicker cross1 section frame. Moreover, by forming the handle 102 of carbon fiber which is cast or molded, thumb and/or finger grips may be easily formed on the handle to improve the grip of the net 100, especially when the net or the user's hands are wet.

A still further advantage of using carbon fiber is that the net 100 is significantly lighter than conventional wooden frames.

Although the invention has been described in detail herein, it should be understood that the invention is not limited to the embodiments herein disclosed. Various changes, substitutions and modifications may be made thereto by those skilled in the art without departing from the spirit or scope of the invention.

I claim:

1. A fishing net, comprising:
a handle;
a frame integrally formed with said handle, said frame defining an open interior; and
a flange integrally formed on said frame, said flange including a plurality of holes for affixing a netting within said open interior.

2. A fishing net as recited in claim 1, said handle, frame and flange formed of a carbon fiber material.

3. A fishing net as recited in claim 1, said handle, frame and flange formed of graphite.

4. A fishing net as recited in claim 1, said handle, frame and flange formed of titanium.

5. A fishing net as recited in claim 1, said handle, frame and flange formed of fiberglass.

6. A fishing net as recited in claim 1, said handle, frame and flange formed by a molding process.

7. A fishing net as recited in claim 1, said handle, frame and flange formed by a casting process.

8. A fishing net as recited in claim 1, said handle including thumb and/or finger grips.

9. A fishing net, comprising:
a handle;
a frame integrally formed with said handle, said frame defining an open interior, said frame including a base portion proximal to said handle, a top portion distal from said handle, and side portions extending between said base portion and said top portion, said top portion having a different cross-sectional shape than said base portion and said side portions; and
a flange integrally formed on said frame, said flange including a plurality of holes for affixing a netting within said open interior.

10. A fishing net as recited in claim 9, said handle, frame and flange formed of a carbon fiber material.

11. A fishing net as recited in claim 9, said handle including thumb and/or finger grips.

12. A fishing net, comprising:
a handle;
a frame integrally formed with said handle, said frame defining an open interior, said frame including a base portion proximal to said handle, a top portion distal from said handle, and side portions extending between said base portion and said top portion, said top portion being flatter than said base portion and said side portions; and
a flange integrally formed on said frame, said flange including a plurality of holes for affixing a netting within said open interior.

13. A fishing net as recited in claim 12, said top portion further being wider than said base portion and said side portions.

14. A fishing net as recited in claim 12, said handle, frame and flange formed of a carbon fiber material.

15. A fishing net as recited in claim 12, said handle including thumb and/or finger grips.

16. A fishing net as recited in claim 12, said handle, frame and flange formed by a molding process.

17. A fishing net as recited in claim 12, said handle, frame and flange formed by a casting process.
